(19) United States
(12) Patent Application Publication
(10) Pub. No.: US 2016/0203244 A1
(43) Pub. Date: Jul. 14, 2016

(54) METHOD AND SYSTEM FOR ASSIGNING A SIGNAL OF A SYMBOL-BASED PROGRAM TO AN I/O FUNCTIONALITY OF A TARGET HARDWARE UNIT

(71) Applicant: dSPACE digital signal processing and control engineering GmbH, Paderborn (DE)

(72) Inventors: Frank MERTENS, Bad Lippspringe (DE); Dirk BERNECK, Paderborn (DE); Martin KRONMUELLER, Salzkotten (DE); Sebastian SCHULTE, Meppen (DE); Henrik SUNDER, Delbrueck (DE); Frank SCHUETTE, Warburg (DE)

(73) Assignee: dSPACE digital signal processing and control engineering GmbH, Paderborn (DE)

(21) Appl. No.: 14/593,709

(22) Filed: Jan. 9, 2015

(51) Int. Cl. G06F 17/50; G06F 9/44

(52) U.S. Cl. CPC G06F 17/5009; G06F 8/30

(57) ABSTRACT

A computer-based system and method for assigning at least one signal of a symbol-based program to at least one I/O functionality of a target hardware unit is provided. A modeling tool has a symbol-based program with the signal that is to be assigned. The signal to be assigned of the symbol-based program and the at least one I/O functionality of the target hardware unit are specified in a configuration tool. Using the modeling tool, an I/O functionality of the target hardware unit is assigned in the symbol-based program to the signal that is to be assigned. A signal assignment information item is generated in the modeling tool from this assignment. The signal assignment information item is transmitted from the modeling tool to the configuration tool, and the configuration tool takes over the assignment to the I/O functionality of the target hardware unit of the signal to be assigned of the symbol-based program according to the signal assignment information item.

### BACKGROUND OF THE INVENTION

1. Field of the Invention

The present invention relates to a computer-implemented method for assigning at least one signal of a symbol-based program to at least one I/O functionality of a target hardware unit, wherein a modeling tool has the symbol-based program with the signal that is to be assigned, and the signal to be assigned of the symbol-based program and the at least one I/O functionality of the target hardware unit are specified in a configuration tool.

The invention further relates to a computer-based system for assigning at least one signal of a symbol-based program to at least one I/O functionality of a target hardware unit, wherein the computer-based system has a modeling tool and a configuration tool, and the modeling tool has the symbol-based program with the signal that is to be assigned, and in addition the signal of the symbol-based program and the at least one I/O functionality of the target hardware unit are specified in the configuration tool.

The invention further relates to a modeling tool for assigning at least one signal of a symbol-based program to at least one I/O functionality of a target hardware unit, wherein the modeling tool has the symbol-based program with the signal that is to be assigned.

The invention further relates to a configuration tool for assigning at least one signal of a symbol-based program to at least one I/O functionality of a target hardware unit, wherein the signal of the symbol-based program and the at least one I/O functionality of the target hardware unit are specified in the configuration tool.

2. Description of the Background Art

Methods and systems for assigning a signal of a symbol-based program to an I/O functionality of a target hardware unit have been known from the dSPACE catalog for some time (e.g., “Catalog 2014”; ConfigurationDesk p. 50-55 and Real-Time Interface (RTI and RTI-MP) p. 56-93, dSPACE GmbH, 2014), and they are frequently used in the fields of development, programming, and testing of control units.

The modeling tool is a tool with which a symbol-based program can be created, which is to say modeled. A modeling tool according to the prior art is depicted in FIG. 1A, which shows a modeling tool 6. The modeling tool 6 runs on a computer 91. The modeling tool 6 contains a symbol-based program 3. The symbol-based program 3 of a technical system is typically an abstract, graphical representation of a technical system or process that actually exists, that is to be developed, and/or that is to be simulated. For example, the symbol-based program is a block-based, iconic, or tree representation of the technical system or process. Executable program code 10 can be generated from the symbol-based program 3 here, for example in that the executable program code 10 is generated from the symbol-based program 3 by a code generator. The code generator can be a functionality of the modeling tool 6 or can be a separate tool.

The technical system is frequently a control system with an electronic computing unit and I/O devices connected to this computing unit. Such technical systems or even processes can be very complex; for example, they can reproduce the complete electronics of a motor vehicle and/or the physical environment of a motor vehicle, and can communicate with other technical systems though their interfaces, which is to say inputs and/or outputs, via signals.

A signal 2 can be an electronic signal, such as, e.g., a voltage, a voltage curve, a current amplitude, an event such as a “voltage reached event,” or complex information, for example a protocol or internal system state on a bus interface.

A signal 2 of this type is processed in the symbol-based program. There is generally a symbol-based representation here for each signal 2, for example a block, a symbol, a textual representation, or a combination thereof.

A configuration tool according to the prior art is shown in FIG. 1B. The configuration tool 7 likewise runs on a computer 91. It contains the signals 2 of the symbol-based program 3 that are to be assigned. These can be depicted by a representation. A representation can be a graphical symbol, for example a block, a symbol, a textual representation, or a combination thereof. In particular, the representation for a signal 2 to be assigned corresponds to its symbol-based depiction in the modeling tool 6. The configuration tool 7 also has I/O functionalities 4 of a target hardware unit 5, which can be assigned to a signal 2 by assignment. Additional details concerning a configuration tool according to the prior art can be found in “Catalog 2014”; ConfigurationDesk p. 50-55, dSPACE GmbH, 2014, for example.

A target hardware unit 5 can also be a target system and is thus a data-processing system having at least one hardware unit with at least one processor and/or FPGA and multiple input channels and/or output channels with which various signals can be measured and/or generated. The type of signal that is to be measured at an input channel or generated at an output channel is defined by the I/O functionality 4, which is to say the input functionality or the output functionality.

A selection of an I/O functionality 4 is at least the selection of a channel or channel type on the target hardware unit 5 to which a signal 2 is to be assigned. The selection of additional characteristics of the channel should also be understood to be included therein. This can be a selection of parameters or a selection of value ranges for a channel, but also a possible fault injection, for example.

If only a channel type and its characteristics are assigned in the configuration tool 7 to a signal 2 that is to be assigned, the configuration tool 7 can automatically suggest a specific assignment to a channel in a channel assignment.

Once the configuration has been defined, which is to say that an I/O functionality 4 has been assigned to each signal that is to be assigned, code can be generated for this configuration. This code is executed on the processor or FPGA of the target hardware unit 5. The target hardware unit 5 then interacts with the technical process according to the configuration that has been defined.

Typical scenarios for the use of such methods, and thus for the interaction of the target hardware unit 5 with the technical process, include hardware-in-the-loop simulation, virtual validation, and rapid control prototyping, for example.

In the hardware-in-the-loop scenario, the control unit, which has application-specific I/O interfaces, is physically present as hardware to be tested. To test the control unit safely and in a simple manner, the environment of the control unit—a physical process—is reproduced in a simulator, which can calculate the physical process in real time, with the aid of a mathematical model, which is to say an environment model. Since this model depicts the technical system in an abstract, frequently block-based form, and appropriate code can be generated from the model, it represents a symbol-based program 3. The signals 2, which is to say the quantities that are to be sensed by the control unit in this scenario through a measurement device and are to be output by the control unit as the response, are output or sensed by measurement device through appropriately programmable I/O interfaces of the simulator. The I/O functionalities 4 for them are now to be defined with regard to the environment model and the target hardware unit 5.

The I/O interface of the control unit typically has a number of hardware functionalities, such as digital and analog inputs/outputs, connections for the output of power signals, interfaces that manage specific communication protocols, or diagnostic interfaces, for example.

With this connection of the signals of the control unit to the inputs and outputs of the environment model, I/O functions 4 can be defined and configured; this determines how the environment model and the control unit are to interact and which control unit input or output is to interact with which part of the model or with which interface of the environment model.

In virtual validation, the control unit is not yet physically present as hardware to be tested, but instead there is only the program code of the control unit, or in other words a virtual control unit. In this case, the program code of the control unit is to be tested, and therefore the interfaces, and thus the signals 2, of the virtual control unit are connected to the symbol-based program 3, which is to say the environment model, through I/O functionalities 4 as in the hardware-in-the-loop scenario.

Other application cases for the generation and use of symbol-based programs 3 of technical systems are classed under the term rapid control prototyping, for example. Here, the control unit and the controller to be implemented on the control unit are constructed and are tested together with the actual technical process. To this end, the inputs and outputs or their signals 2 of the symbol-based program 3 of the simulated control unit or implemented controller are connected to the I/O functionalities 4 and to a target hardware unit 5 and thus, for example, to sensors, actuators, or even to other control units through buses.

In all of these test scenarios for which the model of a technical system or of the parts of a technical system is to be created, the different areas of the test system, which is to say the control unit hardware, I/O interfaces of the simulator, and the symbol-based program of the technical system, are brought together on the simulator.

In the prior art, graphical elements are added to the symbol-based program in the modeling tool. These graphical elements represent an I/O functionality of a target hardware unit 5 and can be connected to signals, which is to say inputs and outputs, of the symbol-based program.

One disadvantage of this method of connecting signals of the symbol-based program to I/O functionalities of a target hardware unit 5 is that the symbol-based program is extended, and thus altered, by the graphical elements. This complicates the simple replacement of the I/O functionality or of the target hardware unit 5, e.g., when a symbol-based program is to be tested with different target hardware units 5, since it is necessary, for example, to replace the entire configuration and thus also all the graphical elements that belong to a configuration.

Another disadvantage is that in the modeling tool only the options provided there for a configuration, in other words an assignment to an I/O functionality of the signals that are to be assigned, are possible. It is not possible to switch to another modeling tool.

This disadvantage is eliminated by ConfigurationDesk from dSPACE, which is to say a configuration tool 7 that is separate from the modeling tool 6. Because of the separation between the model, in other words the symbol-based program 3 in the modeling tool 6, and the configuration tool 7, different configurations can be generated for a symbol-based program 3.

The disadvantage of this separation of the modeling tool 6 and the configuration tool 7 is that the user must become familiar with both tools, which is to say both the modeling tool 6 and the configuration tool 7.

Many users who are familiar with the modeling tool 6 are reluctant to have to deal with an additional configuration tool 7.

### SUMMARY OF THE INVENTION

It is therefore an object of the present invention to provide the user with configuration options in the modeling tool 6 and at the same time to make possible the advantages of the configuration of the I/O functionality 4 separate from the symbol-based program 3.

The object is thus attained through a computer-implemented method for assigning at least one signal 2 of a symbol-based program 3 to at least one I/O functionality 4 of a target hardware unit 5, wherein the method is performed via a modeling tool 6 and a configuration tool 7, and the modeling tool 6 has the symbol-based program 3 with the signal 2 that is to be assigned, and the signal 2 to be assigned of the symbol-based program 3 and the at least one I/O functionality 4 of the target hardware unit 5 are specified in the configuration tool 7. In this design, using the modeling tool 6, an I/O functionality 4 of the target hardware unit 5 is assigned in the symbol-based program 3 to the signal 2 that is to be assigned, wherein a signal assignment information item is created in the modeling tool 6 from this assignment. The signal assignment information item is automatically transmitted from the modeling tool 6 to the configuration tool 7, and the configuration tool 7 takes over the assignment of the signal 2 to be assigned of the symbol-based program 3 to the I/O functionality 4 of the target hardware unit 5 according to the signal assignment information item.

An advantage of this solution is that the user can work in his accustomed modeling tool 6, but the assignment of the signal 2 of the symbol-based program 3 to the I/O functionality 4 takes place in the separate configuration tool 7, so a separate configuration of the I/O functionality 4 of the target hardware unit takes place. It is unimportant in this regard whether the I/O functionality 4 is also present in the modeling tool 6, since the advantage of a separate configuration in the configuration tool 7 is independent therefrom.

It is also unimportant whether the configuration tool 7 is invisible or visible to the user. For example, only a file with the corresponding assignment of the signals 2 to I/O functionalities 4 might be visible to the user.

A signal assignment information item is to be understood to be an item of information that directly or indirectly assigns an I/O functionality 4 to a signal 2 to be assigned of the symbol-based program 3. A direct assignment is, for example, an assignment of a digital output to a digital input I/O functionality. An indirect assignment is present when the signal assignment information item is assigned only to a unique reference point in the configuration tool 7 and this reference point is in turn assigned to an I/O functionality 4, for example.

It is especially advantageous when information from the configuration tool 7 can be used for the assignment of a signal 2 of a symbol-based program 3 to an I/O functionality 4 of a target hardware unit 5, in that at least one input option is provided in the modeling tool 6 for assignment of the signal 2 to be assigned of the symbol-based program 3 to the I/O functionality 4 of the target hardware unit 5 based on at least one I/O functionality information item from the configuration tool 7.

An I/O functionality information item is, for example, a list of all I/O functionalities 4 of the target hardware unit 5 that are specified in the configuration tool 7. Another example of an I/O functionality information item is a list of all I/O functionalities 4 that have not yet been assigned to a signal. Furthermore, an I/O functionality information item can contain information about settings for an I/O functionality 4 that have already been carried out. These examples are not to be understood as being limiting; instead, every item of information about an I/O functionality 4 from the configuration tool 7 can be understood to be an I/O functionality information item.

An input option is a selection option for the user regarding the I/O functionalities, for example. Such a selection option can be a menu selection, a context menu, or a library, for example. The selection can relate to an I/O functionality per se or to settings for an I/O functionality.

As a result of this embodiment, the separation of modeling of the symbol-based program 3 and configuration of the I/O functionality 4 can be implemented still better. The modeling tool primarily provides functionalities for modeling of the symbol-based program 3, whereas, in an especially advantageous embodiment of the invention, information about possible I/O functionalities 4 of the target hardware unit 5 is provided in the modeling tool 6 by the configuration tool 7 and the modeling tool 6 displays this information to a display device, or the user can assign an I/O functionality 4 to a signal 2 of a symbol-based program 3 on the basis of this information.

This embodiment of the invention can also be limited to the necessary information in that the signal 2 to be assigned or the I/O functionality 4 of the target hardware unit 5 is selected in the modeling tool 6, the selection information resulting therefrom is automatically transmitted from the modeling tool 6 to the configuration tool 7, and the configuration tool 7 provides an I/O functionality information item to the modeling tool 6 as a function of the selection information.

This has the advantage that the user is not overwhelmed with all the information available from the configuration tool 7, but instead receives only the I/O functionality information items relevant to them.

Hence, an input option in the modeling tool 6 is not static, but rather is generated dynamically as a function of the configuration tool 7 and/or the settings in the configuration tool 7.

The modeling tool 6 is thus independent of the configuration tool 7; other configuration tools 7 that likewise provide an I/O functionality information item can also be used.

In this process, the I/O functionality information item can be provided by the configuration tool 7 as a function of at least one setting in the configuration tool 7 or also as a function of at least one previous input, for example a mouse operation in the modeling tool 6.

The advantage that the number of possible information items is matched to the context in which a user action takes place is present here, as well.

In another embodiment of the invention, the I/O functionality 4 of the target hardware unit 5 is represented by a graphical access point in the modeling tool 6. For example, the I/O functionality 4 is depicted in the graphical access point by a graphical element such as a block in the symbol-based program 3 in the modeling tool 6 or in a separate window in the modeling tool 6. In another example, the I/O functionality 4 is depicted by a graphical symbol, for example a pictograph, in the symbol-based program 3 in the modeling tool 6 or in a separate window in the modeling tool 6.

Since the symbol-based program 3 is based on graphical elements, it is an advantage here that the I/O functionality 4 can be defined by graphical elements in a manner similar to the way in which the symbol-based program 3 is created and changed.

In an embodiment of the invention, the assignment to the I/O functionality 4 of the target hardware unit 5 of the signal 2 to be assigned of the symbol-based program 3 is accomplished by an assignment to the graphical access point of the signal 2 that is to be assigned. This is an especially convenient option for creating relationships in a symbol-based, graphical environment.

In another embodiment of the invention, after a change in the I/O functionality 4 of the target hardware unit 5 in the configuration tool 7, a change takes place in the graphical access point representing the changed I/O functionality 4′ of the target hardware unit 5 in the modeling tool 6, in particular in the symbol-based program 3 of the modeling tool 6.

This has the advantage that changes to the I/O functionality 4 of the target hardware unit 5 or changes in the assignment of a signal 2 of the symbol-based program 3 to an I/O functionality 4 of the target hardware unit 5 can also be made in the configuration tool 7 as needed, and these changes are then also available in, and can be appropriately incorporated into, the modeling tool 6. The consistency between the assignment of a signal 2 of the symbol-based program 3 to an I/O functionality 4 of the target hardware unit 5 in the modeling tool 6 and in the configuration tool 7 is thus maintained.

This makes it possible to add a configuration, i.e. an assignment of the signals 2 of a symbol-based program 3 to I/O functionalities 4 of the target hardware unit 5 that was created in the configuration tool 7 to a symbol-based program 3 in the modeling tool 6, in that the changes are taken over and, e.g., subsequently processed from the modeling tool 6.

This is especially advantageous when a configuration has been created in the configuration tool 7 and a user who prefers to work with the modeling tool 6 would like to use this configuration in the modeling tool 6.

In another embodiment of the invention, the graphical access point of the I/O functionality 4 of the target hardware unit 5 in the modeling tool 6 corresponds to the depiction of the I/O functionality 4 of the target hardware unit 5 in the configuration tool 7.

In another embodiment of the invention, the information items concerning the I/O functionality 4 of the target hardware unit 5 are stored only in the configuration tool 7, and the graphical access point references these information items.

The object is attained through a computer-based system for assigning at least one signal 2 of a symbol-based program 3 to at least one I/O functionality 4 of a target hardware unit 5, having a modeling tool 6 and a configuration tool 7, wherein the modeling tool 6 has the symbol-based program 3 with the signal 2 that is to be assigned, and the signal 2 to be assigned of the symbol-based program 3 and the at least one I/O functionality 4 of the target hardware unit 5 are specified in the configuration tool 7. In this design, a signal assignment information item is present in the modeling tool 6, wherein the signal assignment information item contains an assignment of the signal 2 to be assigned of the symbol-based program 3 to an I/O functionality 4 or multiple I/O functionalities 4 of the target hardware unit 5, and the configuration tool 7 contains an assignment of the signal 2 to be assigned of the symbol-based program 3 to the I/O functionality 4 of the target hardware unit 5 according to the signal assignment information item from the modeling tool 6.

In another embodiment of the invention, the modeling tool 6 has an input option for assignment of the signal 2 to be assigned of the symbol-based program 3 to the I/O functionality 4 of the target hardware unit 5, wherein the input option is based on at least one I/O functionality information item of the configuration tool 7.

In another embodiment of the invention, the I/O functionality information item in the configuration tool 7 is based on a selection information item relating to the selected signal 2 of the symbol-based program 3 to be assigned or the I/O functionality 4 of the target hardware unit 5 selected in the modeling tool 6.

In another embodiment of the invention, the I/O functionality information item in the configuration tool 7 is based on a setting in the configuration tool 7 or a previous input in the modeling tool 6.

In another embodiment of the invention, the modeling tool 6, in particular the symbol-based program 3, has at least one graphical access point, wherein a graphical access point represents at least one I/O functionality 4 of the target hardware unit 5.

In an embodiment of the invention, the assignment of the signal 2 to be assigned of the symbol-based program 3 to the I/O functionality 4 of the target hardware unit 5 is defined by an assignment of the signal 2 that is to be assigned to the graphical access point.

In another embodiment of the invention, after a change in the I/O functionality 4 of the target hardware unit 5 in the configuration tool 7, the graphical access point in the modeling tool 6, in particular in the symbol-based program 3 of the modeling tool 6, is adapted to the change in the I/O functionality 4 of the target hardware unit 5 in the configuration tool 7.

In addition, the object is attained through a modeling tool 6 with functionality for assigning at least one signal 2 of a symbol-based program 3 to at least one I/O functionality 4 of a target hardware unit 5, wherein the modeling tool 6 has the symbol-based program 3 with the signal 2 that is to be assigned, and a signal assignment information item is present in the modeling tool 6, wherein the signal assignment information item contains an assignment of the signal 2 to be assigned of the symbol-based program 3 to an I/O functionality 4 of the target hardware unit 5, wherein the signal assignment information item of the modeling tool 6 forms the basis for an assignment of the signal 2 to be assigned of the symbol-based program 3 to the I/O functionality 4 of the target hardware unit 5 in a configuration tool 7.

In another embodiment of the invention, the modeling tool 6 has an input option for assignment of the signal 2 to be assigned of the symbol-based program 3 to the I/O functionality 4 of the target hardware unit 5, wherein the input option is based on at least one I/O functionality information item of the configuration tool 7.

Alternatively, the object is attained through a configuration tool 7 for assigning at least one signal 2 of a symbol-based program 3 to at least one I/O functionality 4 of a target hardware unit 5, wherein the signal 2 to be assigned of the symbol-based program 3 and the at least one I/O functionality 4 of the target hardware unit 5 are specified in the configuration tool 7. Moreover, a signal assignment information item from a modeling tool 6 is present in the configuration tool 7, wherein the modeling tool 6 has the symbol-based program 3 with the signal 2 that is to be assigned, and the signal assignment information item contains an assignment of the signal 2 to be assigned of the symbol-based program 3 to an I/O functionality 4 of the target hardware unit 5, and the configuration tool 7 contains an assignment of the signal 2 to be assigned of the symbol-based program 3 to the I/O functionality 4 of the target hardware unit 5 according to the signal assignment information item from the modeling tool 6.

In another embodiment of the invention, the configuration tool 7 has an I/O functionality information item in the configuration tool 7 based on a selection information item relating to the selected signal 2 to be assigned of the symbol-based program 3 or to the I/O functionality 4 of the target hardware unit 5 selected in the modeling tool 6, wherein the I/O functionality information item from the configuration tool 7 forms the basis for the signal assignment information item from the modeling tool 6.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a is a schematic view of a modeling tool in accordance with the prior art,

FIG. 1b is a schematic view of a configuration tool in accordance with the prior art,

FIG. 2 is a schematic view of a system according to the invention pursuant to an embodiment,

FIG. 3 is a schematic view of a method according to the invention pursuant to an embodiment,

FIG. 4 is a schematic view of a method according to the invention pursuant to an embodiment with an I/O functionality information item from the configuration tool,

FIG. 5 is a schematic view of a method according to the invention pursuant to an embodiment with an I/O functionality information item from the configuration tool based on a selection information item from the modeling tool,

FIG. 6 is a schematic view of a method according to the invention pursuant to an embodiment with an I/O functionality information item from the configuration tool that is based on a setting in the configuration tool,

FIG. 7 is a schematic view of a method according to the invention pursuant to an embodiment with an I/O functionality information item from the configuration tool that is based on a previous input in the modeling tool,

FIG. 8 is a schematic view of a system according to the invention pursuant to an embodiment with a graphical access point,

FIG. 9 is a schematic view of a method according to the invention pursuant to an embodiment with a graphical assignment of the signal of the symbol-based program to a graphical access point,

FIG. 10 is a schematic view of a method according to the invention pursuant to another embodiment with a change in the configuration tool and a graphical access point in the modeling tool,

FIG. 11 is a schematic view of a system according to the invention pursuant to another embodiment with a change in the configuration tool and a graphical access point in the modeling tool,

FIG. 12 is a schematic view of a system according to the invention pursuant to an embodiment with an input option in the modeling tool,

FIG. 13 is a schematic view of a system according to the invention pursuant to another embodiment with a selection information item,

FIG. 14 is a schematic view of a system according to the invention pursuant to another embodiment with a previous input,

FIG. 15 is a schematic view of a modeling tool according to the invention,

FIG. 16 is a schematic view of a modeling tool according to the invention with an input option,

FIG. 17 is a schematic view of a configuration tool according to the invention, and

FIG. 18 is a schematic view of a configuration tool according to the invention with an I/O functionality information item.

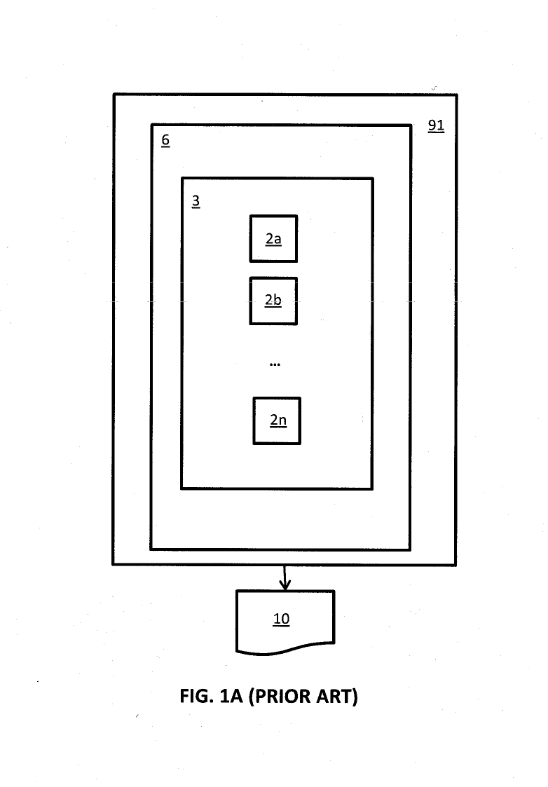

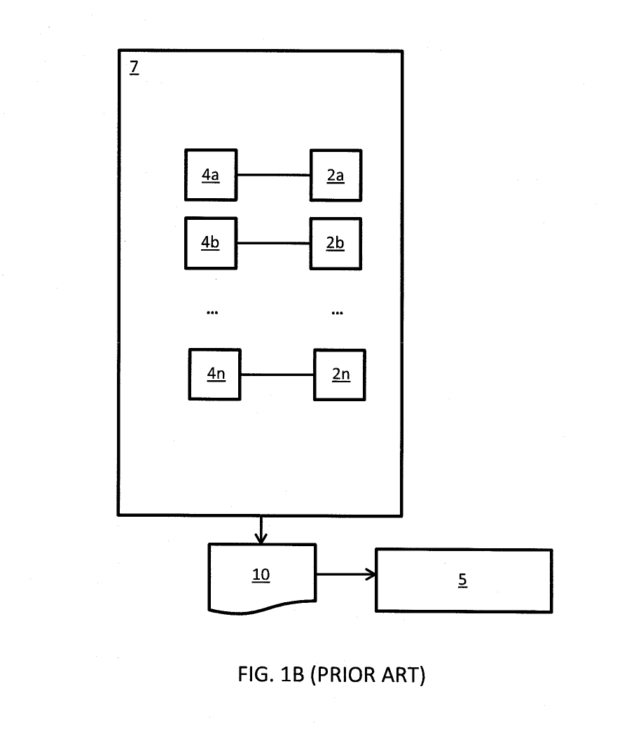

### DETAILED DESCRIPTION

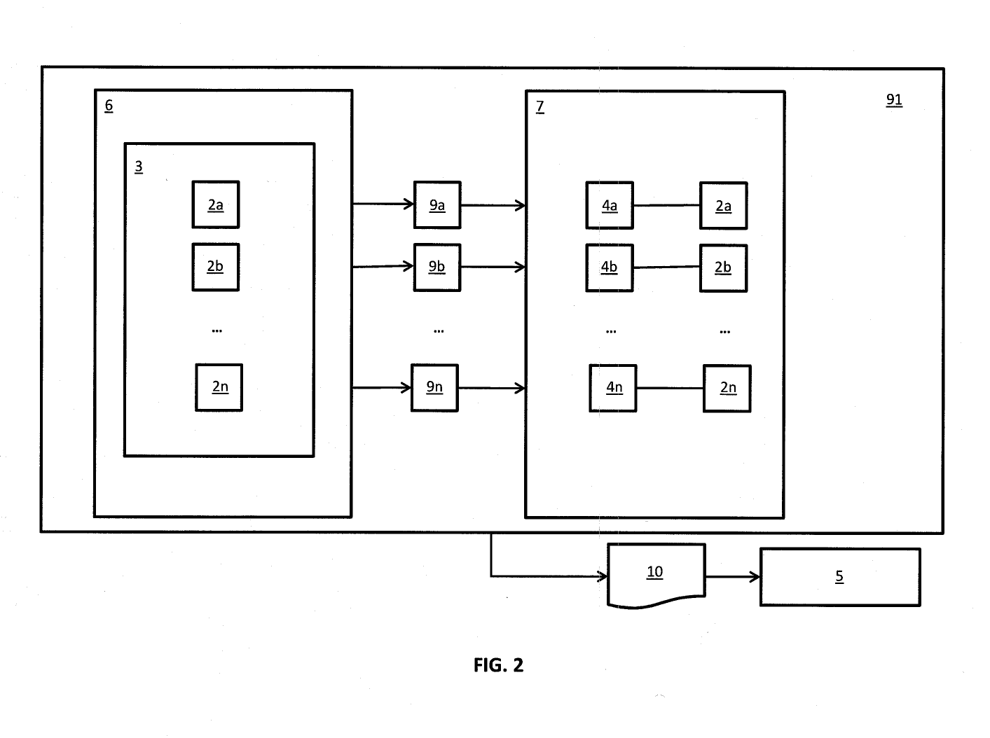

FIG. 2 shows a schematic view of a computer-based system 91 according to the invention pursuant to a first embodiment.

The computer-based system 91 here has a modeling tool 6 and a configuration tool 7. The system 91, which can be networked, can also include a display device(s), user input devices such as a keyboard or a mouse, processors, memories, input and output connections etc.

The modeling tool 6 contains a symbol-based program 3, which is a block-based simulation model of the environment of a control unit, for example. The symbol-based program 3 has inputs and outputs at which signals 2 can be output or measured. In this context, a signal 2 can be an electronic signal, such as, e.g., a voltage, a voltage curve, a current amplitude, or complex information, for example a protocol on a bus interface.

The configuration tool 7 contains at least one signal 2 that can be output via an output to an external device or measured in the symbol-based program 3. A signal 2 can also be depicted by a representation, for example a graphical block or a symbol.

The configuration tool 7 also has I/O functionalities 4. An I/O functionality 4 is at least the selection of a channel or channel type on the target hardware unit 5 to which a signal 2 is to be assigned. The selection of additional characteristics of the channel should also be understood to be included therein. This can be a selection of parameters or a selection of value ranges for a channel, for example, but also a possible fault injection.

The connection of a signal 2 of the symbol-based program 3 to an I/O functionality 4 and the selection of additional characteristics of the I/O functionality 4 defines what kind of signal 2 the target hardware unit 5 should measure at its input of a channel or what kind of signal 2 the target hardware unit 5 should output at its output of a channel.

If only a channel type and its characteristics have been assigned in the configuration tool 7 to a signal 2 of the symbol-based program 3, the configuration tool 7 can automatically suggest a specific assignment to one or more channels in a channel assignment.

A signal assignment information item 9 is created in the modeling tool 6 from an assignment of a signal 2 of the symbol-based program 3 to an I/O functionality 4 in the modeling tool 6, and is available to the configuration tool 7, e.g., because of a transmission from the modeling tool 6 to the configuration tool 7.

Using this signal assignment information item 9, an assignment between the I/O functionality 4 and the signal 2 of the symbol-based program 3 takes place in the configuration tool 7.

Once a configuration, which is to say the assignment of the signals 2 of the symbol-based program 3 to I/O functionalities 4, has been performed, then executable program code 10 that can be executed on the target hardware unit 5 is generated, based on both the symbol-based program 3 and the configuration, for example.

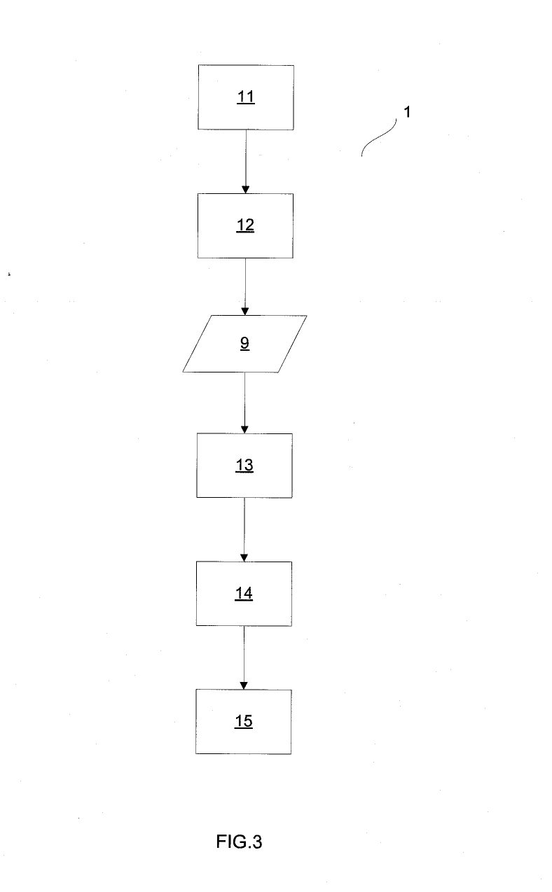

FIG. 3 shows a schematic view of a method 1 according to the invention pursuant to a first embodiment.

In a first step 11, the signal 2 to be assigned of the symbol-based program 3 is selected in the modeling tool 6.

In a step 12, an assignment of the selected signal 2 to an I/O functionality 4 takes place. This assignment produces a signal assignment information item 9.

In a step 13, the signal assignment information item 9 is automatically transmitted from the modeling tool 6 to the configuration tool 7 or is made available to the configuration tool 7. In this case, making available means, for example, that the signal assignment information item 9 is stored by the modeling tool 6 in a memory location of a memory to which the configuration tool 7 also has access.

In a step 14, an assignment of the signal 2 to be assigned of the symbol-based program 3 to the I/O functionality 4 of the target hardware unit 5 takes place in the configuration tool 7 according to the signal assignment information item 9. This takes place in that the signal 2 of the symbol-based program 3 is graphically connected to the I/O functionality 4 that is to be assigned, for example.

In an alternative embodiment in FIG. 3, an I/O functionality 4 is selected in step 11 and is connected to the signal 2 of the symbol-based program 3 in a step 12, and a signal assignment information item 9 is produced from this assignment. The steps 13 and 14 take place as already described.

Step 15 provides that program code that is executed on the target hardware unit 5 is generated based on the symbol-based program and the configuration, which is to say based on the assignment of the signals of the symbol-based program to I/O functionalities.

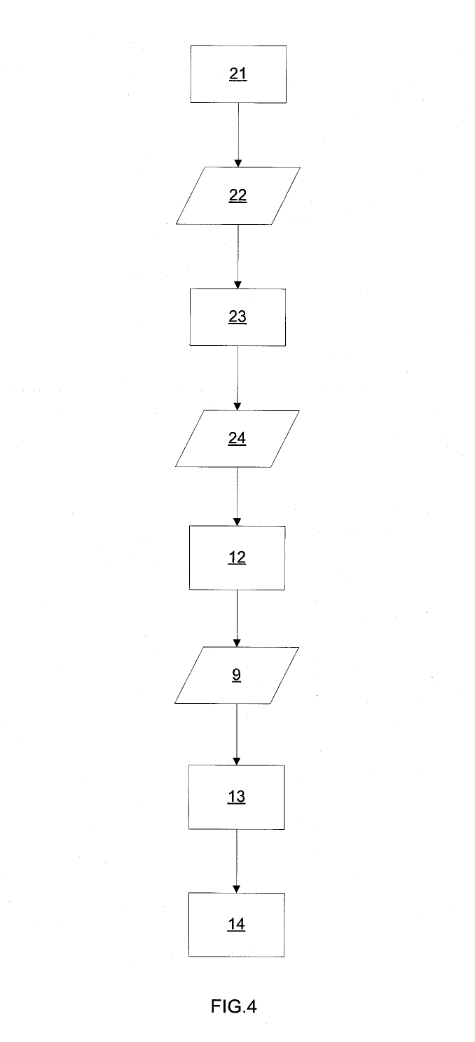

Another embodiment of the method is shown in FIG. 4.

In a step 21, at least one I/O functionality information item 22 is provided to the modeling tool 6 by the configuration tool 7. One such I/O functionality information item 22 is a list of the I/O functionalities 4, for example.

In a step 23, an input option 24 for assignment of the signal 2 to be assigned of the symbol-based program 3 to an I/O functionality 4 of the target hardware unit 5 is provided in the modeling tool 6 based on at least one I/O functionality information item 22 from the configuration tool 7.

Such an input option 24 is, for example, a context menu with a selection list of the I/O functionalities 4 present in the configuration tool 7.

The remaining method steps 12 to 14 are performed as described for FIG. 3.

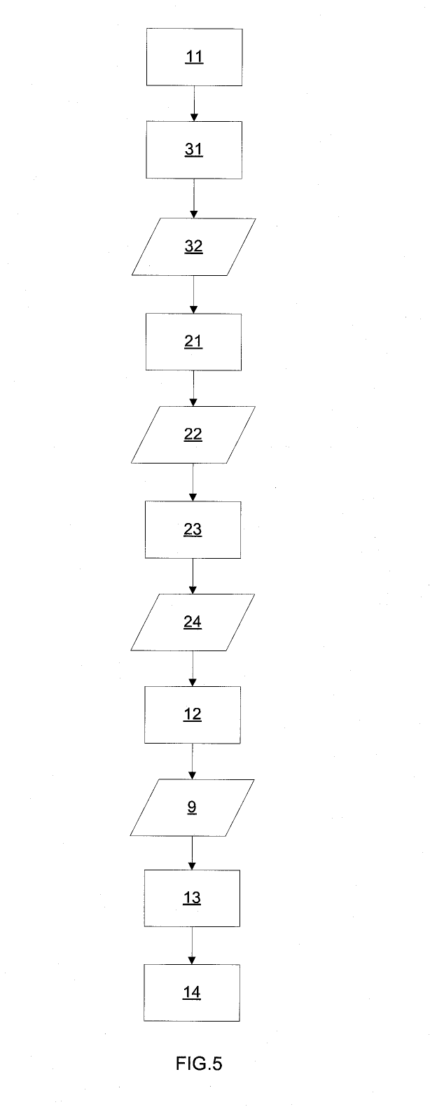

FIG. 5 shows a schematic view of a method according to the invention pursuant to another embodiment with an I/O functionality information item 22 from the configuration tool 7 based on a selection information item 32 from the modeling tool 6.

In this embodiment, a signal 2 to be assigned of the symbol-based program 3, or an I/O functionality 4, is selected in the modeling tool 6 by the user in a method step 11.

In a step 31, the information relating to the selected signal 2 of the symbol-based program 3 or the selected I/O functionality 4 is provided to the configuration tool 7 as selection information 32, for example is transmitted to the configuration tool 7.

In a step 21 at least one I/O functionality information item 22 is provided to the modeling tool 6 by the configuration tool 7. In this process, the selection information 32 influences the I/O functionality information item 22. For example, the I/O functionality information item 22 is limited based on the selection information 32. If the user has selected an analog output signal, for example, no functionality information 22 about input functionalities or digital output functionalities is provided.

The remaining method steps 23 to 14 take place as described for FIG. 4.

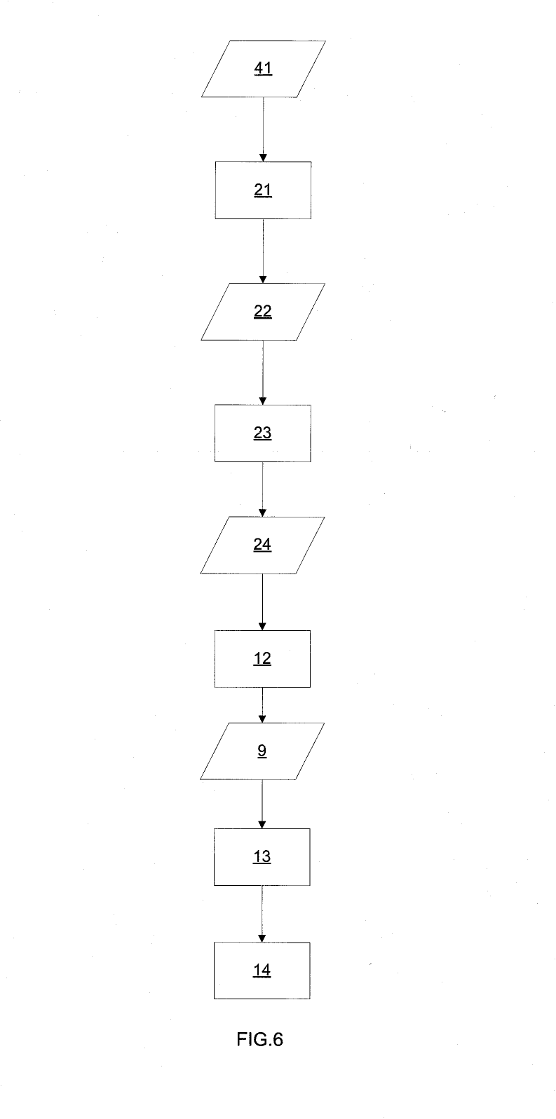

Another embodiment is shown in FIG. 6. In this embodiment, the embodiment shown in FIG. 4 is extended by a setting 41 in the configuration tool 7. The setting 41 in the configuration tool 7 in this embodiment is used to provide the I/O functionality information item 22 in step 21.

The setting 41 in the configuration tool 7 can be the setting of the possible I/O functionalities 4 based on the hardware present, for example, so the I/O functionality information item 22 only contains the I/O functionalities 4 that can be used for a configuration based on the available target hardware unit 5 ascertained in the configuration tool 7.

In another embodiment, the setting 41 includes the hardware resources present in combination with the possible I/O functionalities 4. For example, if only three digital output channels are present based on the hardware resources present and three I/O functionalities 4 have already been used in configurations, the I/O functionality information item 22 shows no additional I/O functionalities 4 for digital output, or shows such an I/O functionality 4 with a warning that an additional digital output channel must be made available in order to use this I/O functionality 4.

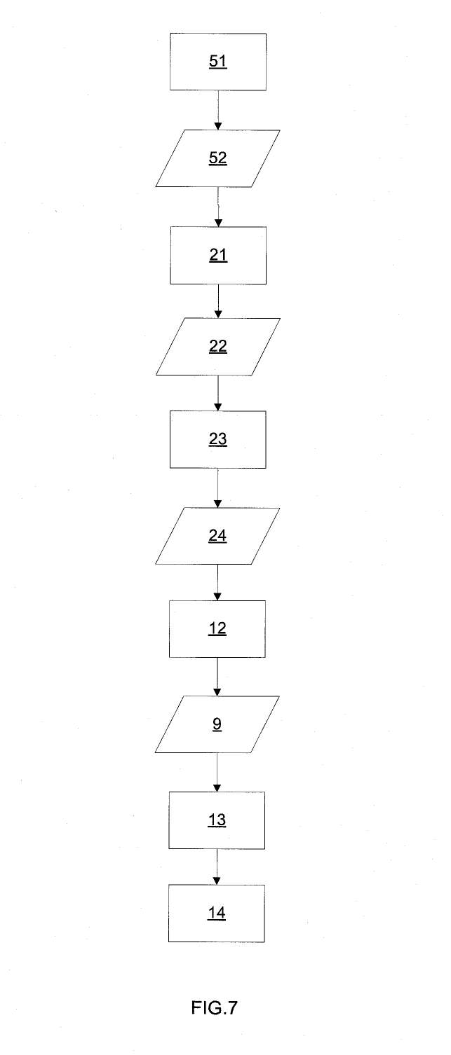

In another embodiment, shown in FIG. 7, the I/O functionality information item 22 is based on a previous input 51 and the input information 52 in the modeling tool 6. An input 51 of this type is, for example, the selection of a signal 2 of the symbol-based program 3 or of an I/O functionality 4 by double-clicking with a mouse or by using the right-hand mouse button. These two mouse inputs can have different meanings and thereby result in different I/O functionality information items 22 from the configuration tool 7.

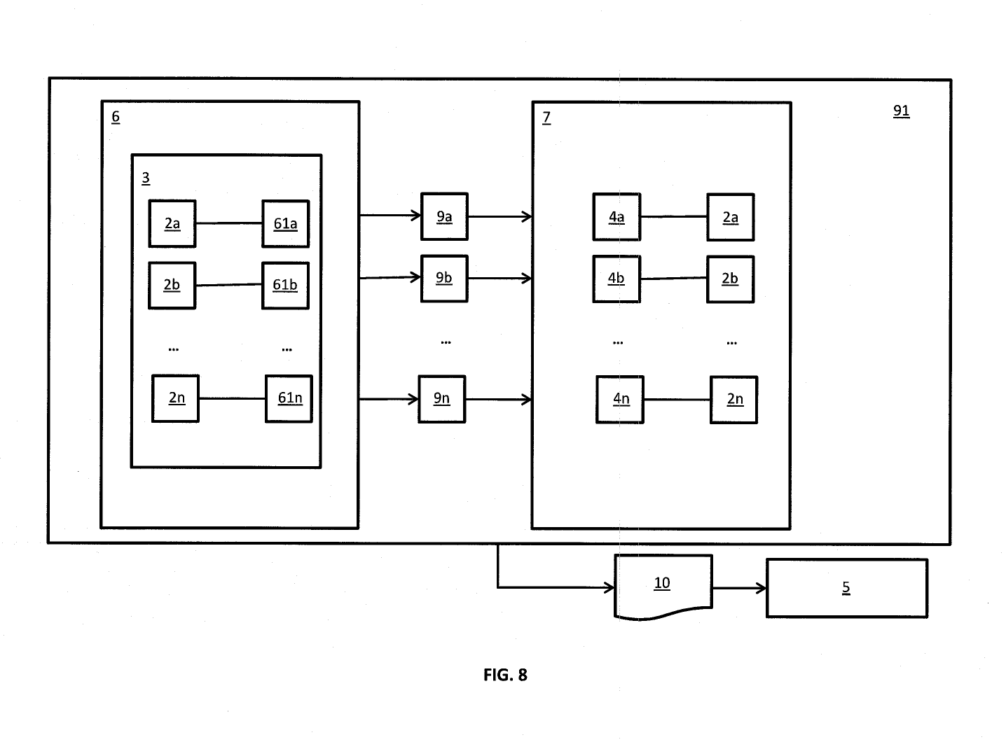

Another embodiment is shown in FIG. 8. It shows a system according to the invention with graphical access points. The structure of the computer-based system corresponds to the greatest degree to the system shown in FIG. 2, which in this embodiment additionally has graphical access points 61a, . . . , 61n for I/O functionalities 4. In this example, there is a graphical access point 61a, . . . , 61n for each I/O functionality 4a, . . . , 4n.

In FIG. 8, the I/O functionality 4 in the graphical access point 61 is depicted by a graphical element such as a block in the symbol-based program 3 in the modeling tool 6.

FIG. 8 also shows another preferred embodiment of the invention, in which the assignment of the signal 2 to be assigned of the symbol-based program 3 to the I/O functionality 4 of the target hardware unit 5 takes place via an assignment of the signal 2 to be assigned of the symbol-based program 3 to the graphical access point 61, so the graphical connections between signal 2a of the symbol-based program 3 and the graphical access point 61a represent the assignment between signal 2a of the symbol-based program 3 and the graphical access point 61a, for example. The user conveniently achieves this assignment by drawing a line between signal 2a and the graphical access point 61a.

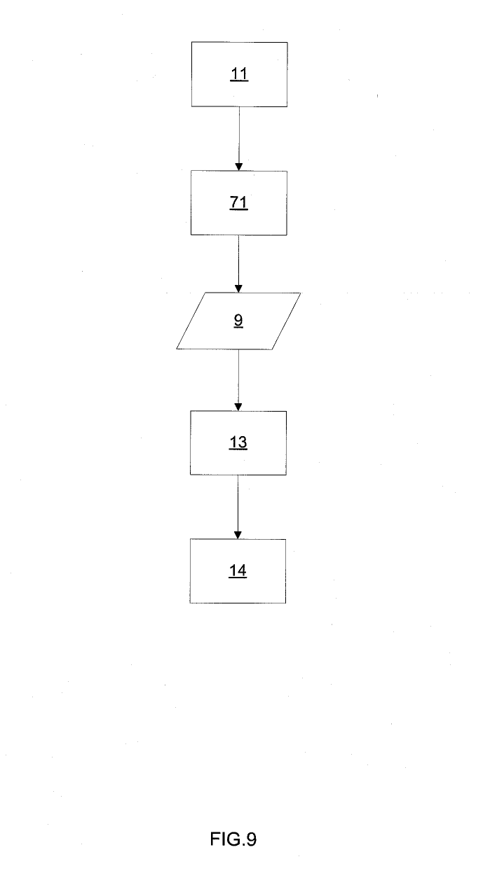

The associated method steps for this exemplary embodiment are shown in FIG. 9. The method steps 11, 13, 14 here correspond to the method steps described for FIG. 3. After selection in step 11 of the signal 2 to be assigned of the symbol-based program 3, in this embodiment the signal 2 to be assigned is graphically connected to a graphical access point 61 in a method step 71, for example in that a line is drawn between the graphical representation of signal 2 and the graphical access point 61. This graphical assignment is subsequently used in the signal assignment information item 9 and is transmitted to the configuration tool 7 in method step 13.

In another exemplary embodiment it is also possible for the user to first select the graphical access point 61 and then graphically connect it to the signal 2 to be assigned of the symbol-based program 3. Here too, this graphical assignment is subsequently used in the signal assignment information item 9 and is transmitted to the configuration tool 7 in method step 13.

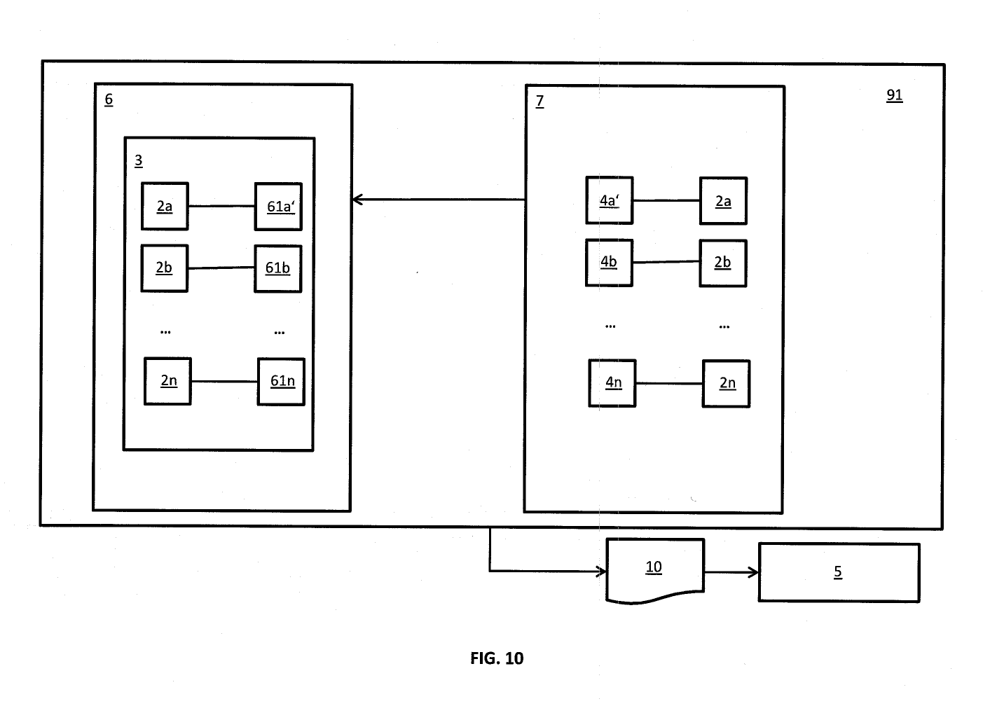

Another embodiment of the invention is shown in FIG. 10. The computer-based system shown corresponds in large part to the system shown in FIG. 8. While the transmission of the signal assignment information item 9 from the modeling tool 6 to the configuration tool 7 is shown in FIG. 8, in FIG. 10 the arrow from the configuration tool 7 to the modeling tool 6 shows that information items are transmitted from the configuration tool 7 to the modeling tool 6. Moreover, the I/O functionality 4a′ shows that the I/O functionality 4a in the configuration tool 7 was changed. This information is transmitted to the modeling tool 6 and the graphical representation 61a is automatically changed to the graphical representation 61a′. Thus, if an output was added to the I/O functionality 4 in the configuration tool 7, for example, so that an underlying I/O function has two outputs instead of one, an output is also added to the graphical representation 61a, especially if each output is graphically depicted in the graphical representation 61.

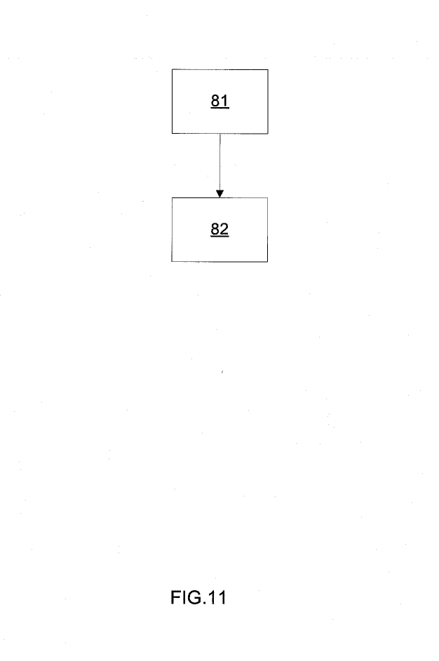

The embodiment of the computer-based system shown in FIG. 10 is shown in FIG. 11 as a method. A change in the I/O functionality 4 in the configuration tool 7 in a method step 81 is followed in a method step 82 by a change in the associated graphical representation 61 in the modeling tool 6.

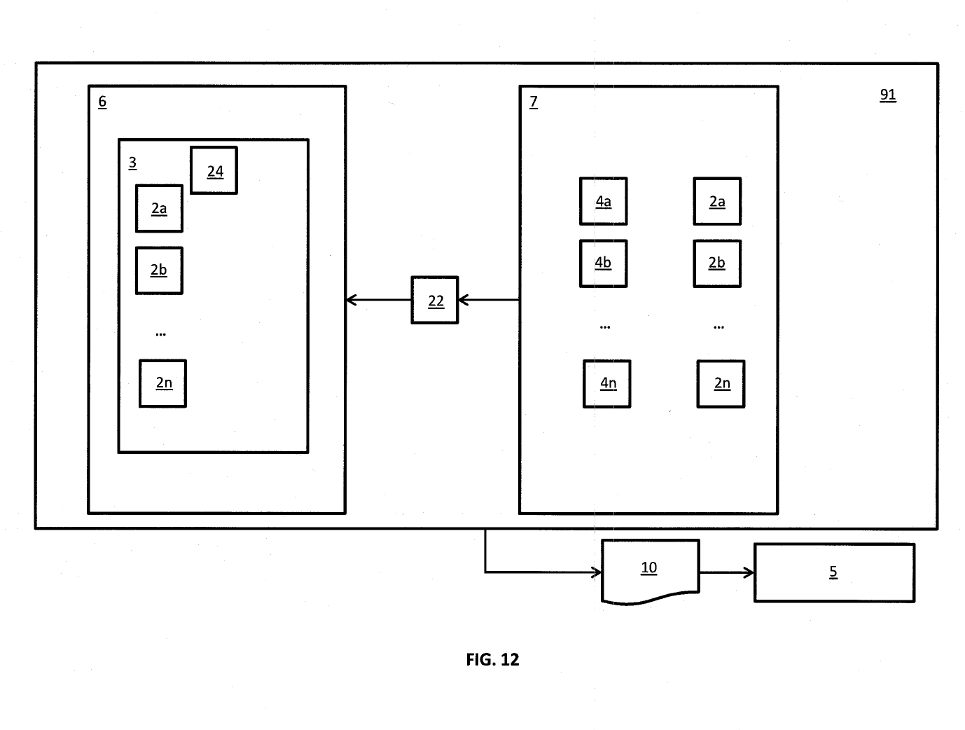

FIG. 12 shows another embodiment in which an I/O functionality information item 22, for example which I/O functionalities 4 are currently available in the configuration tool 7, is transmitted from the configuration tool 7 to the modeling tool 6. This I/O functionality information item 22 is used in the modeling tool 6 to make an input option 24 available to the user. The input option is a selection option of an I/O functionality, for example, and the user receives only the currently available I/O functionalities 4 for selection.

Consequently, an input option 24 in the modeling tool 6 is not static, but rather is generated dynamically as a function of the configuration tool 7 and/or the settings in the configuration tool 7.

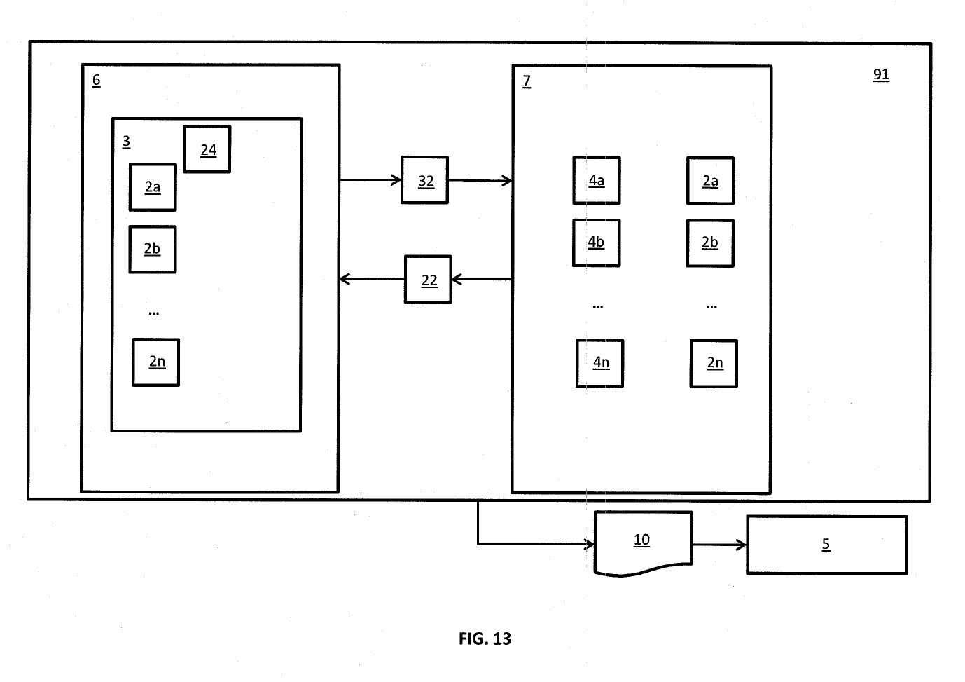

FIG. 13 shows another embodiment. In this embodiment, a selection information item 32 is transmitted to the configuration tool 7. For example, this selection information item 32 contains information regarding which signal 2 to be assigned of the symbol-based program 3 was selected, or which I/O functionality 4 was selected. Using this selection information item 32, the configuration tool 7 generates the I/O functionality information item 22, which is made available to the modeling tool and is used in generating the input option 24.

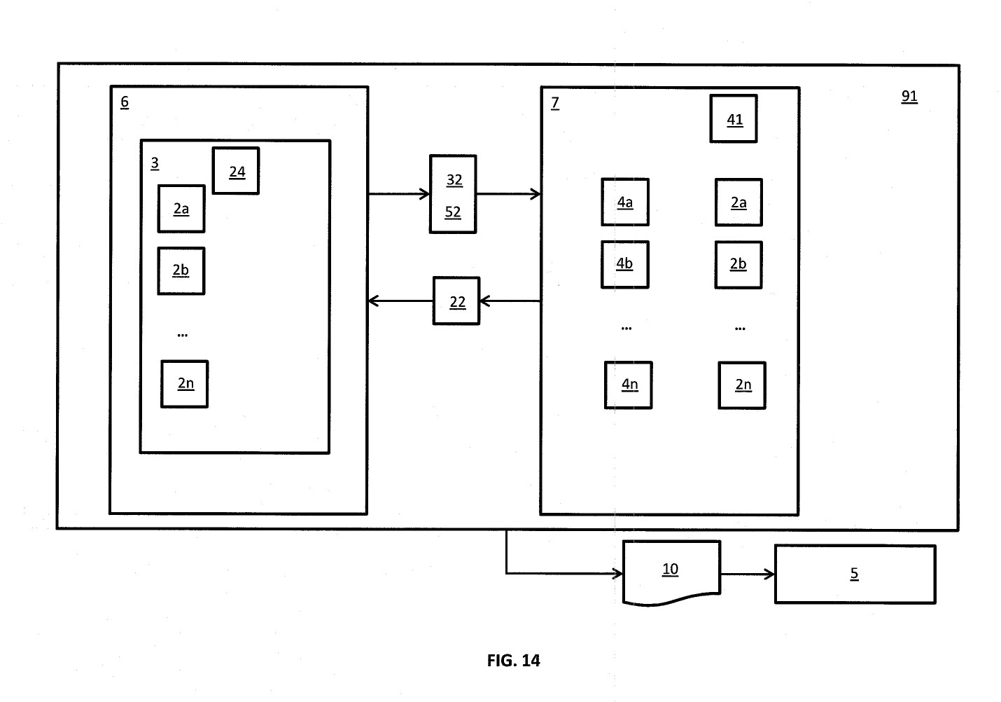

FIG. 14 shows another embodiment of the invention. Here, the I/O functionality information item 22 is based on a previous input and the input information 52 in the modeling tool 6 generated therefrom. An input of this type is, for example, the selection of a signal 2 of the symbol-based program 3 or of an I/O functionality 4 by double-clicking with a mouse or by using the right-hand mouse button. These two mouse inputs can have different meanings and thereby result in different I/O functionality information items 22 from the configuration tool 7.

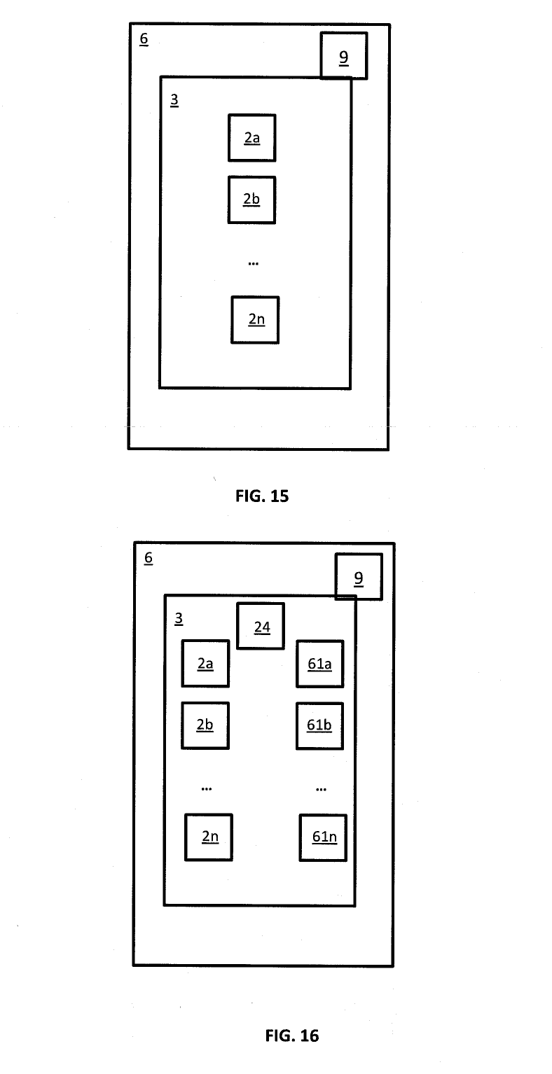

FIG. 15 shows a modeling tool 6 according to the invention with a symbol-based program 3 and signals 2a, . . . , 2n contained therein that are to be assigned. In addition, there is present in the modeling tool 6 a signal assignment information item 9, which contains an assignment of the assigned signal 2 of the symbol-based program 3 to an I/O functionality 4 of the target hardware unit 5 and forms the basis for an assignment of the signal 2 to be assigned of the symbol-based program 3 to the I/O functionality 4 of the target hardware unit 5 in a configuration tool 7.

The signal assignment information item 9 is created when, for example, a user assigns a signal 2 to be assigned of the symbol-based program 3 to an I/O functionality 4.

FIG. 16 shows another embodiment of the invention. This corresponds in large part to FIG. 15. This exemplary embodiment adds a graphical representation 61a, . . . , 61n for I/O functionalities, via which a signal 2 to be assigned of the symbol-based program 3 can be graphically assigned to an I/O functionality. In addition, FIG. 16 shows an input option 24 for assignment of the signal 2 to be assigned of the symbol-based program 3 to the I/O functionality 4 of the target hardware unit 5, wherein the input option 24 is based on at least one I/O functionality information item of the configuration tool. An input option 24 of this type can support the user in selecting a suitable assignment between a signal 2 to be assigned of the symbol-based program 3 and an I/O functionality.

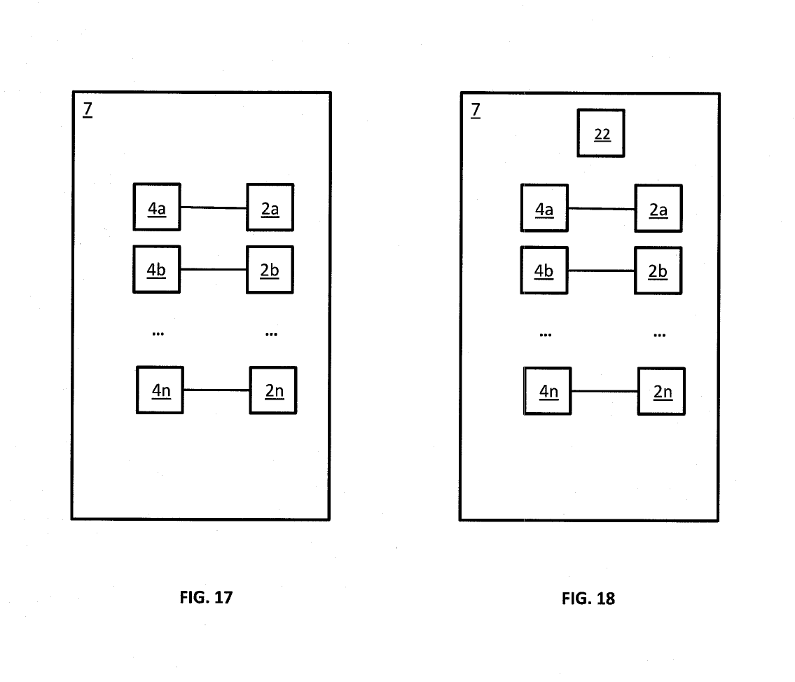

FIG. 17 shows a configuration tool 7 according to the invention with I/O functionalities 4a, . . . , 4n and signals 2a, . . . , 2n, each for a signal to be assigned of the symbol-based program. In this design, an assignment of an I/O functionality 4 to a signal 2 of the symbol-based program takes place using a signal assignment information item from a modeling tool.

Another embodiment of the invention is shown in FIG. 18. This shows a configuration tool 7 according to the invention with an I/O functionality information item 22. In this design, the I/O functionality information item 22 has been generated in the configuration tool 7 based on a selection information item relating to the selected signal to be assigned of the symbol-based program or the selected I/O functionality 4, and forms the basis for an assignment of a signal to be assigned of the symbol-based program to an I/O functionality 4 in a modeling tool.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for assigning at least one signal of a symbol-based program to at least one I/O functionality of a target hardware unit, the method comprising:
providing a modeling tool that has the symbol-based program with the signal that is to be assigned, the signal of the symbol-based program and the at least one I/O functionality of the target hardware unit being specified in a configuration tool;
using the modeling tool, an I/O functionality of the target hardware unit is assigned in the symbol-based program to the signal that is to be assigned;
generating a signal assignment information item in the modeling tool from this assignment;
automatically transmitting the signal assignment information item from the modeling tool to the configuration tool; and
taking over, via the configuration tool, the assignment of the signal to be assigned of the symbol-based program to the I/O functionality of the target hardware unit according to the signal assignment information item.

2. The method according to claim 1, wherein at least one input option is provided in the modeling tool for assignment of the signal to be assigned of the symbol-based program to the I/O functionality of the target hardware unit based on at least one I/O functionality information item from the configuration tool.

3. The method according to claim 2, wherein the signal to be assigned of the symbol-based program or the I/O functionality of the target hardware unit is selected in the modeling tool, a resultant selection information item is automatically transmitted from the modeling tool to the configuration tool, and the configuration tool provides the I/O functionality information item to the modeling tool based on the selection information item.

4. The method according to claim 2, wherein the at least one I/O functionality information item is provided by the configuration tool as a function of at least one setting in the configuration tool.

5. The method according to claim 2, wherein the at least one I/O functionality information item from the configuration tool is provided as a function of at least one previous input in the modeling tool.

6. The method according to claim 1, wherein the I/O functionality of the target hardware unit is represented by a graphical access point in the modeling tool or in the symbol-based program of the modeling tool.

7. The method according to claim 6, wherein the assignment of the signal to be assigned of the symbol-based program to the I/O functionality of the target hardware unit takes place through an assignment to the graphical access point of the signal to be assigned of the symbol-based program.

8. The method according to claim 6, wherein after a change in the I/O functionality of the target hardware unit in the configuration tool, a change takes place in the graphical access point representing the changed I/O functionality of the target hardware unit in the modeling tool or in the symbol-based program of the modeling tool.

9. The computer-based system for assigning at least one signal of a symbol-based program to at least one I/O functionality of a target hardware unit, the system comprising:
a modeling tool having the symbol-based program with the signal that is to be assigned, the signal of the symbol-based program and the at least one I/O functionality of the target hardware unit being specified in the configuration tool; and
a signal assignment information item provided in the modeling tool, the signal assignment information item containing an assignment of the assigned signal of the symbol-based program to an I/O functionality of the target hardware unit,
wherein the configuration tool contains an assignment of the signal to be assigned of the symbol-based program to the I/O functionality of the target hardware unit according to the signal assignment information item from the modeling tool.

10. The computer-based system according to claim 9, wherein the modeling tool has an input option for assignment of the signal to be assigned of the symbol-based program to the I/O functionality of the target hardware unit, and wherein the input option is based on at least one I/O functionality information item of the configuration tool.

11. The computer-based system according to claim 10, wherein the I/O functionality information item in the configuration tool is based on a selection information item relating to the selected signal to be assigned of the symbol-based program or the I/O functionality of the target hardware unit selected in the modeling tool.

12. The computer-based system according to claim 10, wherein the I/O functionality information item in the configuration tool is based on a setting in the configuration tool or a previous input in the modeling tool.

13. The computer-based system according to claim 9, wherein the modeling tool or the symbol-based program has at least one graphical access point, and wherein the graphical access point represents at least one I/O functionality of the target hardware unit.

14. The computer-based system according to claim 13, wherein the assignment of the signal to be assigned of the symbol-based program to the I/O functionality of the target hardware unit is defined by an assignment of the signal to be assigned of the symbol-based program to the graphical access point representing the I/O function.

15. The computer-based system according to claim 13, wherein, after a change in the I/O functionality of the target hardware unit in the configuration tool, the graphical access point in the modeling tool or in the symbol-based program of the modeling tool is adapted to the change in the I/O functionality of the target hardware unit in the configuration tool.

16. A modeling tool with functionality for assigning at least one signal of a symbol-based program to at least one I/O functionality of a target hardware unit, the modeling tool comprising the symbol-based program with the signal that is to be assigned, wherein a signal assignment information item is provided in the modeling tool, wherein the signal assignment information item contains an assignment of the signal to be assigned of the symbol-based program to an I/O functionality of the target hardware unit, and wherein the signal assignment information item of the modeling tool forms a basis for an assignment of the signal to be assigned of the symbol-based program to the I/O functionality of the target hardware unit in a configuration tool.

17. The modeling tool according to claim 16, wherein the modeling tool has an input option for assignment of the signal to be assigned of the symbol-based program to the I/O functionality of the target hardware unit, and wherein the input option is based on at least one I/O functionality information item of the configuration tool.

18. A configuration tool for assigning at least one signal of a symbol-based program to at least one I/O functionality of a target hardware unit,
wherein the signal to be assigned of the symbol-based program and the at least one I/O functionality of the target hardware unit are specified in the configuration tool,
wherein a signal assignment information item from a modeling tool is present in the configuration tool,
wherein the signal assignment information item contains an assignment of the signal to be assigned of the symbol-based program to the I/O functionality of the target hardware unit, and
wherein the configuration tool contains an assignment of the assigned signal of the symbol-based program to an I/O functionality of the target hardware unit based on the signal assignment information item from the modeling tool of the configuration tool.

19. The configuration tool according to claim 18, wherein the configuration tool has an I/O functionality information item in the configuration tool based on a selection information item relating to the selected signal to be assigned of the symbol-based program or to the I/O functionality of the target hardware unit selected in the modeling tool, and wherein the I/O functionality information item from the configuration tool forms the basis for the signal assignment information item in the modeling tool.
